(19) United States
(12) Patent Application Publication
(10) Pub. No.: US 2012/0194573 A1
(43) Pub. Date: Aug. 2, 2012

(54) LIQUID CRYSTAL DISPLAY DEVICE

(75) Inventors: Yuki Yamashita, Osaka-shi (JP); Akihiro Shohraku, Osaka-shi (JP); Masanori Takeuchi, Osaka-shi (JP)

(73) Assignee: SHARP KABUSHIKI KAISHA, Osaka-shi, Osaka (JP)

(21) Appl. No.: 13/395,954

(22) PCT Filed: Aug. 27, 2010
(86) PCT No.: PCT/JP2010/064609

§ 371 Date: Mar. 14, 2012

(30) Foreign Application Priority Data
Sep. 25, 2009 (JP) 2009-221393

(51) Int. Cl. G09G 3/36; G09G 5/10

(52) U.S. Cl. 345/690; 345/88; 345/89

(57) ABSTRACT

In the liquid crystal display device (100) of this invention, pixels include m kinds of (where m is an even number and m≧4) pixels (R, G, B and Y) that display different colors. The pixels are arranged so that n of the m kinds of pixels (where n is an even number, n≦m and n is a divisor of m) are repeatedly arranged in the same order in the row direction. Each row of pixels formed by those pixels includes groups of pixels, to each of which n pixels arranged consecutively in the row direction belong. Grayscale voltages of opposite polarities are applied through associated signal lines (13) to the pixel electrodes (11) of two arbitrary adjacent pixels in each group of pixels. In two arbitrary groups of pixels that are adjacent in the row direction, grayscale voltages of opposite polarities are applied through their associated signal lines to the pixel electrodes of pixels that display the same color. The signal lines include at least one pair of adjacent signal lines (13p) to supply grayscale voltages of the same polarity. The source-drain capacitance of the pixels located between the pair of signal lines is smaller than that of the other pixels. The present invention can improve the display quality of a liquid crystal display device, of which each picture element is defined by an even number of pixels.

### TECHNICAL FIELD

The present invention relates to a liquid crystal display device and more particularly relates to a liquid crystal display device that conducts a display operation in colors by using four or more kinds of pixels that display mutually different colors.

### BACKGROUND ART

Liquid crystal display devices are currently used in a variety of applications. In a general liquid crystal display device, one picture element consists of three pixels respectively representing red, green and blue, which are the three primary colors of light, thereby conducting a display operation in colors.

A conventional liquid crystal display device, however, can reproduce colors that fall within only a narrow range (which is usually called a “color reproduction range”), which is a problem. Thus, to broaden the color reproduction range of liquid crystal display devices, a technique for increasing the number of primary colors for use to perform a display operation has recently been proposed.

For example, Patent Document No. 1 discloses a liquid crystal display device 800 in which one picture element P is made up of four pixels that include not only red, green and blue pixels R, G and B representing the colors red, green and blue, respectively, but also a yellow pixel Y representing the color yellow as shown in FIG. 22. That liquid crystal display device 800 performs a display operation in colors by mixing together the four primary colors red, green, blue and yellow that are represented by those four pixels R, G, B and Y.

By performing a display operation using four or more primary colors, the color reproduction range can be broadened compared to a conventional liquid crystal display device that uses only the three primary colors for display purposes. Such a liquid crystal display device that conducts a display operation using four or more primary colors will be referred to herein as a “multi-primary-color liquid crystal display device”. And a liquid crystal display device that conducts a display operation using the three primary colors will be referred to herein as a “three-primary-color liquid crystal display device”.

On the other hand, Patent Document No. 2 discloses a liquid crystal display device 900 in which one picture element P is made up of four pixels that include not only red, green and blue pixels R, G and B but also a white pixel W representing the color white as shown in FIG. 23. As the pixel added is a white pixel W, that liquid crystal display device 900 cannot broaden the color reproduction range but can still increase the display luminance.

However, if one picture element P is made up of an even number of pixels as in the liquid crystal display devices 800 and 900 shown in FIGS. 22 and 23, a so-called “horizontal shadow” phenomenon will arise and debase the display quality when a dot inversion drive operation is carried out. The dot inversion drive is a technique for minimizing the occurrence of a flicker on the display screen and is a driving method in which the polarity of the applied voltage is inverted on a pixel-by-pixel basis.

FIG. 24 shows the polarities of voltages applied to respective pixels when a dot inversion drive operation is carried out on a three-primary-color liquid crystal display device. On the other hand, FIGS. 25 and 26 show the polarities of voltages applied to respective pixels when a dot inversion drive operation is carried out on the liquid crystal display devices 800 and 900, respectively.

In a three-primary-color liquid crystal display device, the polarities of the voltages applied to pixels in the same color invert in the row direction as shown in FIG. 24. For example, in the first, third and fifth rows of pixels shown in FIG. 24, the voltages applied to the red pixels R go positive (+), negative (−) and positive (+) in this order from the left to the right. The voltages applied to the green pixels G go negative (−), positive (+) and negative (−) in this order. And the voltages applied to the blue pixels B go positive (+), negative (−) and positive (+) in this order.

In the liquid crystal display devices 800 and 900, on the other hand, each picture element P is made up of an even number of (i.e., four in this case) pixels. That is why in each and every row of pixels, the voltages applied to pixels in the same color have the same polarity everywhere as shown in FIGS. 25 and 26. For example, in the first, third and fifth rows of pixels shown in FIG. 25, the polarities of the voltages applied to every red pixel R and every yellow pixel Y are positive (+) and those of the voltages applied to every green pixel G and every blue pixel B are negative (−). Meanwhile, in the first, third and fifth rows of pixels shown in FIG. 26, the polarities of the voltages applied to every red pixel R and every blue pixel B are positive (+) and those of the voltages applied to every green pixel G and every white pixel W are negative (−).

If the voltages applied to pixels in the same color come to have the same polarity anywhere in the row direction in this manner, a horizontal shadow will be cast when a window pattern is displayed in a single color. Hereinafter, it will be described with reference to FIG. 27 why such a horizontal shadow is cast.

As shown in FIG. 27(a), when a high-luminance window WD is displayed on a low-luminance background BG, horizontal shadows SD, which have a higher luminance than the background to be displayed originally, are sometimes cast on the right- and left-hand sides of the window WD.

FIG. 27(b) illustrates an equivalent circuit of a portion of a normal liquid crystal display device that covers two pixels. As shown in FIG. 27(b), each of these pixels has a thin-film transistor (TFT) 14. A scan line 12, a signal line 13 and a pixel electrode 11 are respectively electrically connected to the gate, source and drain electrodes of the TFT 14.

A liquid crystal capacitor C_{LC} is formed by the pixel electrode 11, a counter electrode 21 that is arranged to face the pixel electrode 11, and a liquid crystal layer that is interposed between the pixel electrode 11 and the counter electrode 21. Meanwhile, a storage capacitor C_{CS} is formed by a storage capacitor electrode 17 that is electrically connected to the pixel electrode 11, a storage capacitor counter electrode 15a that is arranged to face the storage capacitor electrode 17, and a dielectric layer (i.e., an insulating film) interposed between the storage capacitor electrode 17 and the storage capacitor counter electrode 15a.

The storage capacitor counter electrode 15a is electrically connected to a storage capacitor line 15 and supplied with a storage capacitor counter voltage (CS voltage). FIGS. 27(c) and 27(d) show how the CS voltage and the gate voltage change with time. It should be noted that write voltages (i.e., grayscale voltages applied to the pixel electrode 11 through the signal line 13) have mutually different polarities in FIGS. 27(c) and 27(d).

When the gate voltage goes high to start charging a pixel, the potential of the pixel electrode 11 (i.e., its drain voltage) changes. In the meantime, a ripple voltage is superposed on the CS voltage by way of a parasitic capacitor between the drain and the CS as shown in FIGS. 27(c) and 27(d). As can be seen by comparing FIGS. 27(c) and 27(d), the polarity of the ripple voltage inverts according to that of the write voltage.

The ripple voltage superposed on the CS voltage attenuates with time. If the write voltage has small amplitude (i.e., when the write voltage is applied to pixels that display the background BG), the ripple voltage goes substantially zero when the gate voltage goes low. On the other hand, if the write voltage has large amplitude (i.e., when the write voltage is applied to pixels that display the window WD), the ripple voltage becomes relatively high compared to those pixels that display the background BG. As a result, as shown in FIGS. 27(c) and 27(d), even when the gate voltage goes low, the ripple voltage superposed on the CS voltage has not quite attenuated yet. That is to say, even after the gate voltage has gone low, the ripple voltage continues to attenuate. Consequently, due to that residual ripple voltage v a , the drain voltage (i.e., the pixel electrode potential) affected by the CS voltage varies from its original level.

On the same row of pixels, two ripple voltages of opposite polarities work to cancel each other, but two ripple voltages of the same polarity will superpose one upon the other. That is why if the voltages applied to pixels in the same color come to have the same polarity everywhere in the row direction as shown in FIGS. 25 and 26, horizontal shadows will be cast when a window pattern is displayed in a single color.

Patent Document No. 3 discloses a technique for avoiding casting such horizontal shadows. FIG. 28 illustrates a liquid crystal display device 1000 as disclosed in Patent Document No. 3.

As shown in FIG. 28, the liquid crystal display device 1000 includes an LCD panel 1001, including a number of picture elements P each consisting of red, green, blue and white pixels R, G, B and W, and a source driver 1003 that supplies a display signal to multiple signal lines 1013 of the LCD panel 1001.

The source driver 1003 includes a plurality of individual drivers 1003a, each of which is connected to an associated one of the signal lines 1013. Those individual drivers 1003a are arranged side by side in the row direction. And each pair of individual drivers 1003a that are adjacent to each other output grayscale voltages of mutually opposite polarities.

In the liquid crystal display device 1000 shown in FIG. 28, some of those signal lines 13 are arranged in reverse order outside of the display area. For example, the fifth and sixth signal lines 1013 as counted from the left in FIG. 28 are arranged to intersect with each other outside of the display area. As a result, the fifth and sixth signal lines 1013 are connected to the sixth and fifth individual drivers 1003a, respectively. In the liquid crystal display device 1000 with such an arrangement, grayscale voltages of mutually opposite polarities are applied to the respective pixel electrodes of two pixels that display the same color and that belong to two picture elements P that are adjacent to each other in the row direction. Consequently, the voltages applied to those pixels that are arranged in the row direction to display the same color do not have the same polarity, thus avoiding casting such horizontal shadows.

### Citation List

### Patent Literature

Patent Document No. 1: PCT International Application Japanese National Phase Publication No. 2004-529396

Patent Document No. 2: Japanese Patent Application Laid-Open Publication No. 11-295717

Patent Document No. 3: PCT International Application Publication No. 2007/063620

### SUMMARY OF INVENTION

1. Technical Problem

If the technique disclosed in Patent Document No. 3 is adopted, however, particular pixels will be interposed between two signal lines 1013 that apply grayscale voltages of the same polarity. In the arrangement shown in FIG. 28, blue pixels B are located between a signal line 1013 associated with their own pixel electrodes and a signal line 1013 associated with the pixel electrodes of their adjacent white pixels W, and the grayscale voltages supplied through these two signal lines 1013 have the same polarity. Consequently, those pixels located between the two signal lines 1013 that supply the voltages of the same polarity come to have display luminances that are no longer the original levels as will be described in detail later. As a result, the display quality will decline.

It is therefore an object of the present invention to improve the display quality of such a liquid crystal display device of which each picture element is defined by an even number of pixels.

### Solution To Problem

A liquid crystal display device according to the present invention has a number of pixels, which are arranged in columns and rows to form a matrix pattern. The device includes: an active-matrix substrate that includes pixel electrodes, each of which is provided for an associated one of the pixels, a plurality of scan lines that run in a row direction, and a plurality of signal lines that run in a column direction; a counter substrate that faces the active-matrix substrate; a liquid crystal layer that is interposed between the active-matrix substrate and the counter substrate; and a signal line driver that applies a positive or negative grayscale voltage as a display signal to each said signal line. Those pixels include m kinds of (where m is an even number that is equal to or greater than four) pixels that display mutually different colors. The pixels are arranged so that n out of the m kinds of pixels (where n is an even number that is equal to or smaller than m and is a divisor of m) are repeatedly arranged in the same order in the row direction. Each of the rows of pixels that are formed by those pixels includes multiple groups of pixels, to each of which n pixels that are arranged consecutively in the row direction belong. Grayscale voltages of mutually opposite polarities are applied through associated signal lines to the pixel electrodes of two arbitrary pixels that are adjacent to each other in each said group of pixels. In two arbitrary ones of those groups of pixels that are adjacent to each other in the row direction, grayscale voltages of mutually opposite polarities are applied through their associated signal lines to the pixel electrodes of pixels that display the same color. The signal lines include at least one pair of signal lines that are adjacent to each other and that supply grayscale voltages of the same polarity. And the source-drain capacitance of the pixels that are located between the pair of signal lines is smaller than the source-drain capacitance of the other pixels.

In one preferred embodiment, when viewed along a normal to a display screen, each said pixel electrode and its associated two adjacent signal lines overlap with each other. The area where the pixel electrodes of the pixels that are located between the pair of signal lines and the two signal lines that are adjacent to those pixels overlap with each other is smaller than the area where the pixel electrodes of the other pixels and the two signal lines that are adjacent to those pixels overlap with each other.

In this particular preferred embodiment, the pixel electrode of each of the pixels that are located between the pair of signal lines has notches.

In another preferred embodiment, when viewed along a normal to a display screen, each said pixel electrode and its associated two adjacent signal lines do not overlap with each other, and the distance from the pixel electrodes of the pixels that are located between the pair of signal lines to the two signal lines that are adjacent to those pixel electrodes is longer than the distance from the pixel electrodes of the other pixels to the two signal lines that are adjacent to those pixel electrodes.

In still another preferred embodiment, the active-matrix substrate further includes shield electrodes, which are arranged in the vicinity of edges of the pixel electrode of each said pixel that is located between the pair of signal lines and which are supplied with a different voltage from the grayscale voltage applied to the pixel electrode.

In yet another preferred embodiment, the pixels include red, green and blue pixels representing the colors red, green and blue, respectively.

In a specific preferred embodiment, the pixels further include yellow pixels representing the color yellow.

In a more specific preferred embodiment, the pixels that are located between the pair of signal lines are the blue pixels.

In yet another preferred embodiment, m=n, and the pixels are arranged so that the m kinds of pixels are repeatedly arranged in the same order in the row direction.

In this particular preferred embodiment, each said group of pixels forms one picture element.

In yet another preferred embodiment, the signal line driver includes a plurality of output terminals that are arranged in the row direction, and two arbitrary adjacent ones of the output terminals output grayscale voltages of opposite polarities.

In a specific preferred embodiment, the liquid crystal display device includes connection regions where each of the signal lines is connected to an associated one of the output terminals one to one. The connection regions include a sequential connection region where an i^{th} signal line (where i is a natural number) and an i^{th} output terminal are connected together and reverse connection regions where a j^{th} signal line (where j is a different natural number from i) and a (j+1)^{th} output terminal are connected together and where a (j+1)^{th} signal line and a j^{th} output terminal are connected together.

In yet another preferred embodiment, the signal line driver includes a plurality of output terminals that are arranged in the row direction. The output terminals include multiple groups of output terminals, each said group including n output terminals that are arranged consecutively in the row direction. In each said group of output terminals, two arbitrary adjacent ones of the output terminals output grayscale voltages of opposite polarities. In two arbitrary ones of the groups of output terminals that are adjacent to each other in the row direction, two output terminals at the same position output grayscale voltages of opposite polarities.

### Advantageous Effects of Invention

The present invention improves the display quality of a liquid crystal display device, of which each picture element is defined by an even number of pixels.

### BRIEF DESCRIPTION OF DRAWINGS

FIG. 1 illustrates a liquid crystal display device 100 as a preferred embodiment of the present invention.

FIG. 2 is a plan view schematically illustrating a region of the liquid crystal display device 100 according to the preferred embodiment of the present invention, which is allocated to a pixel.

FIG. 3 is a cross-sectional view of the liquid crystal display device 100 according to the preferred embodiment of the present invention as viewed on the plane 3A-3A′ shown in FIG. 2.

FIG. 4 schematically illustrates the LCD panel 1 and signal line driver 3 of the liquid crystal display device 100.

FIGS. 5(a) and 5(b) show why the display quality is debased in a conventional liquid crystal display device.

FIG. 6 is a plan view schematically illustrating regions of the liquid crystal display device 100 according to the preferred embodiment of the present invention, which are allocated to four pixels that are arranged consecutively in the row direction.

FIG. 7 is a plan view schematically illustrating regions of the liquid crystal display device 100 according to the preferred embodiment of the present invention, which are allocated to four pixels that are arranged consecutively in the row direction.

FIG. 8 is a plan view schematically illustrating regions of a liquid crystal display device 200 as another preferred embodiment of the present invention, which are allocated to four pixels that are arranged consecutively in the row direction.

FIG. 9 is a plan view schematically illustrating regions of the liquid crystal display device 200 according to the preferred embodiment of the present invention, which are allocated to four pixels that are arranged consecutively in the row direction.

FIG. 10 is a plan view schematically illustrating regions of a liquid crystal display device 300 as still another preferred embodiment of the present invention, which are allocated to four pixels that are arranged consecutively in the row direction.

FIGS. 11(a) and 11(b) respectively illustrate, on a larger scale, the areas A1 and A2 that are indicated by the dashed circles in FIG. 10.

FIG. 12 is a plan view schematically illustrating regions of a liquid crystal display device 400A as yet another preferred embodiment of the present invention, which are allocated to four pixels that are arranged consecutively in the row direction.

FIG. 13 is a plan view schematically illustrating regions of a liquid crystal display device 400B as yet another preferred embodiment of the present invention, which are allocated to four pixels that are arranged consecutively in the row direction.

FIG. 14 is a plan view schematically illustrating regions of a liquid crystal display device 400C as yet another preferred embodiment of the present invention, which are allocated to four pixels that are arranged consecutively in the row direction.

FIGS. 15(a) and 15(b) respectively illustrate, on a larger scale, the areas A3 and A4 that are indicated by the dashed circles in FIG. 14.

FIG. 16 is a plan view schematically illustrating regions of the liquid crystal display device 400A according to yet another preferred embodiment of the present invention, which are allocated to four pixels that are arranged consecutively in the row direction.

FIG. 17 is a plan view schematically illustrating regions of the liquid crystal display device 400B according to yet another preferred embodiment of the present invention, which are allocated to four pixels that are arranged consecutively in the row direction.

FIG. 18 illustrates a modified example of a liquid crystal display device according to a preferred embodiment of the present invention.

FIG. 19 illustrates a modified example of a liquid crystal display device according to a preferred embodiment of the present invention.

FIG. 20 illustrates a modified example of a liquid crystal display device according to a preferred embodiment of the present invention.

FIG. 21 illustrates a modified example of a liquid crystal display device according to a preferred embodiment of the present invention.

FIG. 22 schematically illustrates a conventional liquid crystal display device 800.

FIG. 23 schematically illustrates another conventional liquid crystal display device 900.

FIG. 24 shows the polarities of voltages applied to respective pixels when a dot inversion drive operation is carried out on a three-primary-color liquid crystal display device.

FIG. 25 shows the polarities of voltages applied to respective pixels when a dot inversion drive operation is carried out on the conventional liquid crystal display device 800.

FIG. 26 shows the polarities of voltages applied to respective pixels when a dot inversion drive operation is carried out on the conventional liquid crystal display device 900.

FIGS. 27(a) to 27(d) show how horizontal shadows are cast.

FIG. 28 schematically illustrates still another conventional liquid crystal display device 1000.

### DESCRIPTION OF EMBODIMENTS

Hereinafter, preferred embodiments of the present invention will be described with reference to the accompanying drawings. It should be noted, however, that the present invention is in no way limited to the preferred embodiments to be described below.

### Embodiment 1

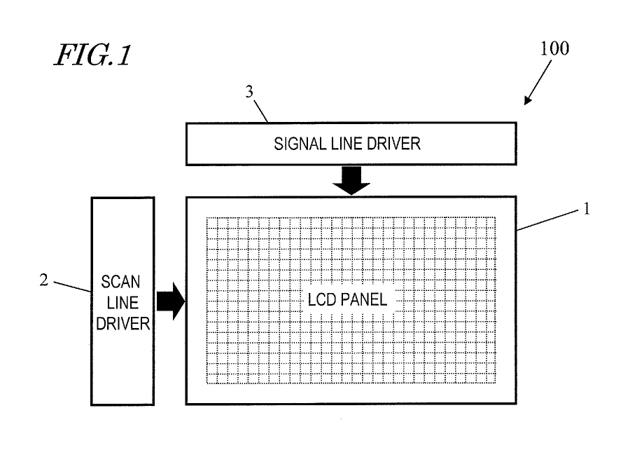

FIG. 1 illustrates a liquid crystal display device 100 as a first specific preferred embodiment of the present invention. As shown in FIG. 1, the liquid crystal display device 100 includes an LCD panel 1 with a number of pixels that are arranged in columns and rows to form a matrix pattern, and a scan line driver (or gate driver) 2 and a signal line driver (or source driver) 3 that supply a drive signal to the LCD panel 1.

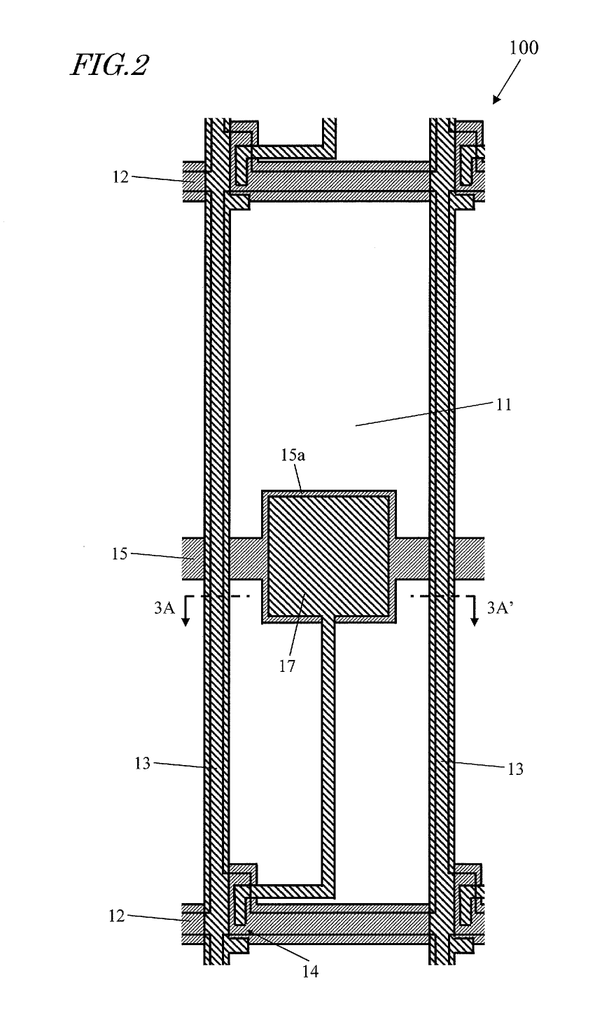

FIGS. 2 and 3 illustrate a specific structure for the LCD panel 1. Specifically, FIG. 2 is a plan view illustrating a region of the LCD panel 1 that is allocated to a pixel, and FIG. 3 is a cross-sectional view thereof as viewed on the plane 3A-3A′ shown in FIG. 2.

The LCD panel 1 includes an active-matrix substrate 10, a counter substrate 20 that faces the active-matrix substrate 10, and a liquid crystal layer 30 that is interposed between the active-matrix substrate 10 and the counter substrate 20.

The active-matrix substrate 10 includes a pixel electrode 11, which is provided for each of a number of pixels, a plurality of scan lines 12 that run in the row direction, and a plurality of signal lines 13 that run in the column direction. The pixel electrode 11 is supplied with a scan signal from its associated scan line 12 via a thin-film transistor (TFT) 14 and is also supplied with a display signal from its associated signal line 13.

The scan lines 12 are arranged on a transparent substrate (e.g., a glass substrate) 10a with electrically insulating properties. On the transparent substrate 10a, also arranged is a storage capacitor line 15 that runs in the row direction. The storage capacitor line 15 and the scan lines 12 are made of the same conductor film. A portion 15a of the storage capacitor line 15, which is located around the center of the pixel, has a broader width than any other portion and functions as a storage capacitor counter electrode, which is supplied with a storage capacitor counter voltage (CS voltage) from the storage capacitor line 15.

A gate insulating film 16 is arranged to cover the scan lines 12 and the storage capacitor line 15. On the gate insulating film 16, arranged are the signal lines 13 and a storage capacitor electrode 17, which are both made of the same conductor film. The storage capacitor electrode 17 is electrically connected to the drain electrode of the TFT 14. And the storage capacitor electrode 17 and the pixel electrode 11 are supplied with the same voltage via the TFT 14.

An interlayer insulating film 18 is arranged to cover the signal lines 13 and the storage capacitor electrode 17. The pixel electrode 11 is located on the interlayer insulating film 18. The pixel electrode 11 is arranged so that its edges overlap with the scan lines 12 and the signal lines 13 with the interlayer insulating film 18 interposed between them.

An alignment film 19 is arranged on the uppermost surface of the active-matrix substrate 10 to contact with the liquid crystal layer 30. The alignment film 19 may be either a horizontal alignment film or a vertical alignment film depending on the mode of display to take.

The counter substrate 20 includes a counter electrode 21, which faces the pixel electrode 11 and which is arranged on a transparent substrate (such as a glass substrate) 20a with electrically insulating properties. An alignment film 29 is arranged on the uppermost surface of the counter substrate 20 to contact with the liquid crystal layer 30. The alignment film 29 may be either a horizontal alignment film or a vertical alignment film depending on the mode of display to take. Although not shown in any of the drawings, the counter substrate 20 typically further includes a color filter layer and an opaque layer (i.e., a black matrix).

The liquid crystal layer 30 includes liquid crystal molecules that have either positive or negative dielectric anisotropy depending on the mode of display to take, and a chiral agent as needed.

In the LCD panel 1 with such a structure, a liquid crystal capacitor C_{LC} is formed by the pixel electrode 11, the counter electrode 21 that faces the pixel electrode 11, and the liquid crystal layer 30 interposed between those electrodes 11 and 21. Also, a storage capacitor C_{CS} is formed by the storage capacitor electrode 17, the storage capacitor counter electrode 15a that faces the storage capacitor electrode 17, and the gate insulating film 16 interposed between those electrodes 17 and 15a. And a pixel capacitance Cpix is formed by the liquid crystal capacitor C_{LC} and the storage capacitor C_{CS} that is arranged in parallel to the liquid crystal capacitor C_{LC}.

The scan line driver 2 supplies a scan signal to each of those scan lines 12 of the LCD panel 1. On the other hand, the signal line driver 3 supplies a positive or negative grayscale voltage as a display signal to each of the signal lines 13 of the LCD panel 1.

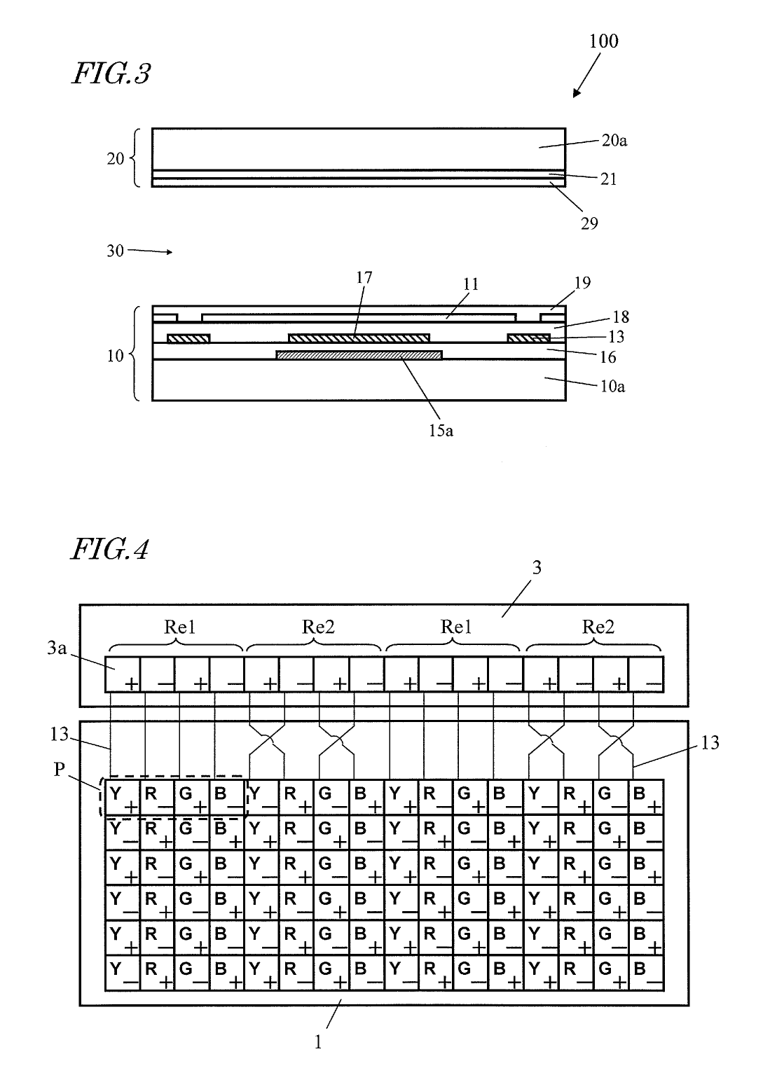

Hereinafter, the relation between the arrangement of pixels in the LCD panel 1 and the polarities of the grayscale voltages applied from the signal line driver 3 to the respective pixels by way of the signal lines 13 will be described with reference to FIG. 4. It should be noted that the polarities of the grayscale voltages are determined by reference to the voltage applied to the counter electrode 21 (which will be referred to herein as a “counter voltage”).

As shown in FIG. 4, the pixels include red, green, blue, and yellow pixels R, G, B and Y representing the colors red, green, blue, and yellow, respectively. That is to say, the pixels of the LCD panel 1 include four kinds of pixels that represent mutually different colors. In association with those red, green, blue, and yellow pixels R, G, B and Y, the color filter layer of the counter substrate 20 includes red, green, blue, and yellow color filters that transmit red, green, blue, and yellow rays, respectively.

Those pixels are arranged so that the four kinds of pixels are repeatedly arranged in the same order in the row direction. Specifically, in this example, those pixels are arranged recursively in the order of yellow, red, green and blue pixels Y, R, G and B from the left to the right.

One picture element P, which is the minimum unit to conduct a display operation in colors, is formed by a set of four pixels that are arranged consecutively in the row direction. That is why each of the multiple rows of pixels includes a number of picture elements P. And in each of those picture elements P, the four kinds of pixels are arranged in the order of yellow, red, green and blue pixels Y, R, G and B from the left to the right.

In each of the multiple picture elements P, grayscale voltages of mutually opposite polarities are applied through associated signal lines 13 to the pixel electrodes 11 of two arbitrary adjacent pixels. Likewise, grayscale voltages of mutually opposite polarities are also applied through an associated signal line 13 to the pixel electrodes 11 of two arbitrary pixels that are adjacent to each other in the column direction.

As described above, in the liquid crystal display device 100, the polarity of the grayscale voltage inverts every pixel in the column direction. In the same way, in the row direction, the polarity of the grayscale voltage also inverts every pixel in each picture element P. In this manner, the liquid crystal display device 100 performs an inversion drive that is similar to the dot inversion drive. Also, in the liquid crystal display device 100, in two arbitrary ones of the picture elements P that are adjacent to each other in the row direction, grayscale voltages of mutually opposite polarities are applied through their associated signal lines 13 to the pixel electrodes 11 of pixels that display the same color. That is why it is possible to prevent the voltages applied to multiple pixels representing the same color in the row direction from having the same polarity, thus avoiding casting horizontal shadows.

Such an inversion drive that can avoid casting horizontal shadows can be carried out by connecting the signal lines 13 to the signal line driver 3 as shown in FIG. 4.

The signal line driver 3 includes a plurality of output terminals 3a that are arranged in the row direction.

Two arbitrary adjacent ones of the output terminals 3a output grayscale voltages of opposite polarities. Each of those output terminals 3a of the signal line driver 3 is connected one to one to an associated one of the signal lines 13 of the LCD panel 1. If regions where those output terminals 3a are connected to the signal lines 13 are referred to as “connection regions”, those connection regions include two kinds of regions Re1 and Re2. Hereinafter, those regions Re1 and Re2 will be described in detail. In the following description, those signal lines 13 will be counted from the left to the right in FIG. 4 and will be referred to herein as “first, second, third signal lines 13” and so on. In the same way, those output terminals 3a will also be counted from the left to the right in FIG. 4 and will also be referred to herein as “first, second, third output terminals 3a” and so on.

As shown in FIG. 4, in each of the regions Re1, an i^{th} signal line 13 (where i is a natural number) and an i^{th} output terminal 3a are connected together. That is to say, the signal lines 13 and the output terminals 3a are connected together sequentially. That is why this kind of regions Re1 will be referred to herein as “sequential connection regions”. For example, in the sequential connection region Re1 shown on the left-hand side of FIG. 4, the first signal line 13 and the first output terminal 3a are connected together, so are the second signal line 13 and the second output terminal 3a, the third signal line 13 and the third output terminal 3a, and the fourth signal line 13 and the fourth output terminal 3a.

On the other hand, in each of the regions Re2, a j^{th} signal line 13 (where j is a different natural number from i) and a (j+1)^{th} output terminal 3a are connected together and a (j+1)^{th} signal line 13 and a j^{th} output terminal 3a are connected together. That is to say, the signal lines 13 and the output terminals 3a are not connected sequentially but in reverse order. That is why this kind of regions Re2 will be referred to herein as “reverse connection regions”. For example, in the reverse connection region Re2 shown on the left-hand side of FIG. 4, the fifth signal line 13 and the sixth output terminal 3a are connected together, so are the sixth signal line 13 and the fifth output terminal 3a, the seventh signal line 13 and the eighth output terminal 3a, and the eighth signal line 13 and the seventh output terminal 3a.

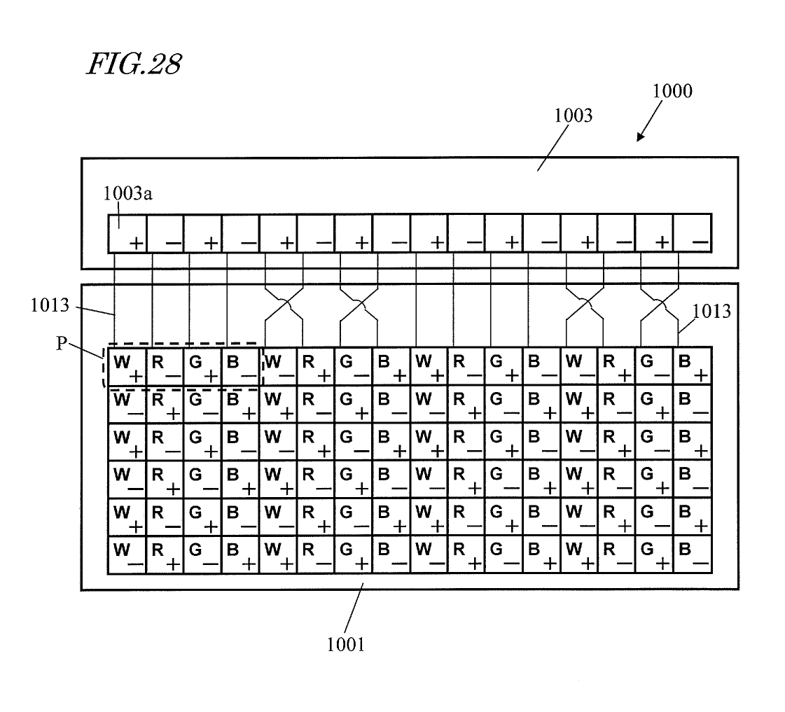

Since there are such sequential connection regions Re1 and reverse connection regions Re2 in the same mixture as described above, an inversion drive can be carried out with the horizontal shadows eliminated. If such an inversion drive is carried out, however, pixels representing a certain color will be interposed between two signal lines 13 that supply grayscale voltages of the same polarity. For example, in the arrangement shown in FIG. 4, the blue pixels B are located between the signal line 13 that supplies a grayscale voltage to the pixel electrodes 11 of those blue pixels 11 and the signal line 13 that supplies a grayscale voltage to the pixel electrodes 11 of adjacent yellow pixels Y on the right-hand side of the blue pixels B. And the grayscale voltages supplied through these two signal lines 13 have the same polarity. In the conventional liquid crystal display device 1000 shown in FIG. 28, such pixels that are located between two signal lines that supply voltages of the same polarity come to have a different display luminance from the original level, thus debasing the display quality. On the other hand, the liquid crystal display device 100 of this preferred embodiment can minimize such a decline in display quality. Before the reason is described in detail, it will be described first with reference to FIG. 5 why the display quality is debased in the conventional liquid crystal display device 1000.

As shown in FIG. 5(a), when a display signal (i.e., a source signal) supplied to a signal line 13 after a pixel has been charged changes, the potential at its pixel electrode 11 (i.e., a drain voltage) also varies by way of the parasitic capacitance between the source and the drain (i.e., a source-drain capacitance Csd). In that case, the magnitude Δ v of the variation can be calculated by the following Equation (1) using the magnitude of variation (i.e., amplitude) Vspp of the source signal, the source-drain capacitance Csd and the pixel capacitance Cpix:

ΔV=Vspp·(Csd/Cpix) (1)

In general, the potential at the pixel electrode 11 of a certain pixel is affected by not only a variation in voltage on the signal line 13 that supplies a grayscale voltage to the pixel electrode 11 of that pixel (and that will be sometimes referred to herein as “its own source”) but also by a variation in voltage on the signal line 13 that supplies a grayscale voltage to the pixel electrode 11 of a pixel that is adjacent to the former pixel in the row direction (and that will be sometimes referred to herein as “others' source”). For that reason, if the polarities of its own source signal and others' source signal are opposite to each other as shown in FIG. 5(b), the variation Δ v in potential at the pixel electrode 11 is canceled.

In the conventional liquid crystal display device 1000, however, since its own source signal and others' source signal have the same polarity in each of the pixels that are located between two signal lines that supply voltages of the same polarity, Δ v is not canceled. As a result, the drain voltage decreases by Δ v and the effective voltage applied to the liquid crystal layer decreases, too. Consequently, the display luminance varies from the original level, and the image on the screen darkens and the display quality gets debased in the normally black mode.

Next, it will be described why the liquid crystal display device 100 of this preferred embodiment can minimize such a decline in display quality.

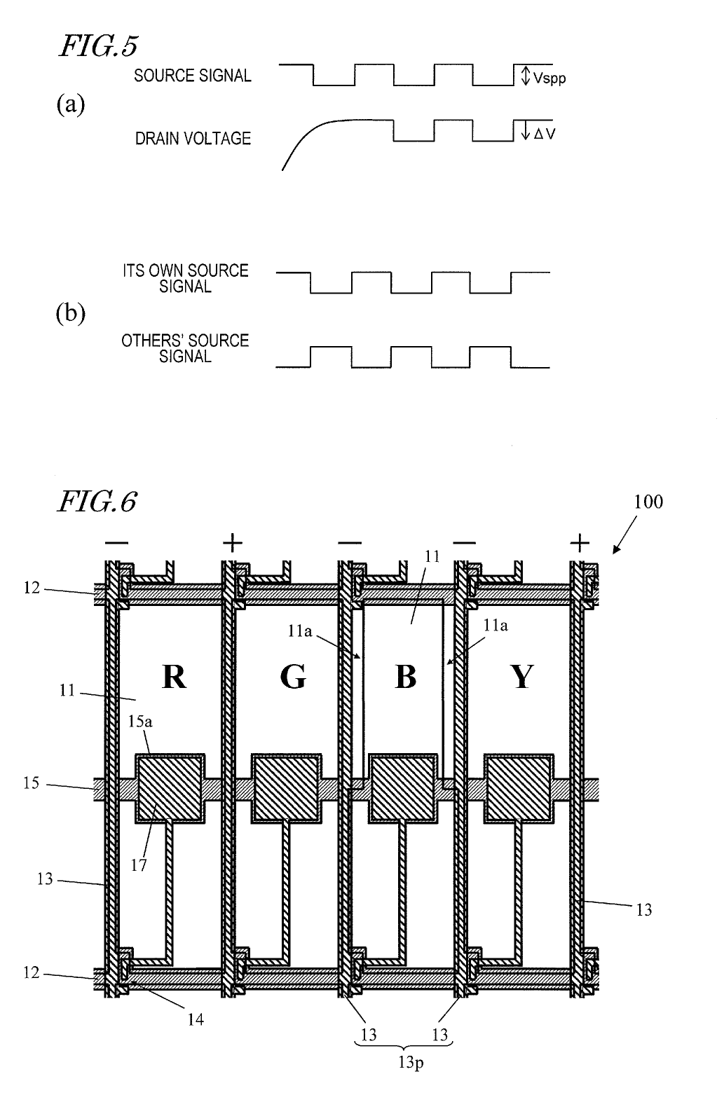

FIG. 6 illustrates four pixels that are arranged consecutively in the row direction in the liquid crystal display device 100. Specifically, the four pixels shown in FIG. 6 are red, green, blue, and yellow pixels R, G, B and Y from the left to the right. As described above, in this liquid crystal display device 100, the blue pixels B are located between two signal lines 13 that supply voltages of the same polarity. That is to say, the blue pixels B are located between a pair of signal lines 13p consisting of two signal lines 13 that are adjacent to each other and that supply grayscale voltages of the same polarity. On the other hand, each of the red, green and yellow pixels R, G and Y is located between two signal lines 13 that supply voltages of opposite polarities.

In the liquid crystal display device 100 of this preferred embodiment, the pixel electrode 11 of the blue pixel B has a different shape from the pixel electrodes 11 of the red, green and yellow pixels R, G and Y. Specifically, the pixel electrode 11 of the blue pixel B has two notches 11a (i.e., portions that are present in the pixel electrode 11 of the other pixels but absent from this pixel electrode 11). In this example, the two notches 11a are the respective upper halves of the rightmost and leftmost portions of the pixel electrode 11 and are substantially rectangular. However, this is only an example and the number and shape of the notches 11a may be different from the ones adopted in this example.

When viewed along a normal to the display screen, the pixel electrode 11 of each pixel overlaps with two adjacent signal lines 11. However, as the pixel electrode 11 of the blue pixel B has such notches 11a, the combined area where the pixel electrode 11 of the blue pixel B overlaps with two adjacent signal lines 13 is smaller than the combined area where the pixel electrode 11 of any other pixel overlaps with two adjacent signal lines 13.

That is why the source-drain capacitance Csd of the blue pixel B is smaller than that of any other pixel. Consequently, the magnitude of variation Δ v in drain voltage represented by Equation (1) decreases so much that the display luminance of the blue pixel B varies much less and the decline in display quality can be minimized.

To enhance the effect of minimizing the decline in display quality, it is preferred for the following reason that the source-drain capacitance Csd of the blue pixel B be set to be approximately a half or less of that of any other pixel. If a display operation is performed in a single color by another pixel that is located between two signal lines 13 that supply voltages of opposite polarities (i.e., unless others' source signal varies), the magnitudes of variation Δ v₁ and Δ v₂ in drain voltage due to the influence of its own source and others' source are represented by the following Equations (2) and (3), respectively. Consequently, the magnitude of the total variation Δ V_{Total} is represented by the following Equation (4):

Δv₁=vspp·(Csd/Cpix) (2)

Δv₂=0 (3)

Δv_{Total}=Δv₁+Δv₂=vspp·(Csd/Cpix) (4)

On the other hand, if a display operation is performed by the blue pixel B that is located between two signal lines 13 that supply voltages of the same polarities (i.e., if its own source signal and others' source signal both vary), the magnitudes of variation Δ v₁ and Δv₂ in drain voltage due to the influence of its own source and others' source are represented by the following Equations (5) and (6), respectively. Consequently, the magnitude of the total variation Δv_{Total} is represented by the following Equation (7):

Δv₁=vspp·(Csd/Cpix) (5)

Δv₂=vspp (Csd/Cpix) (6)

Δv_{Total}=Δv₁+Δv₂·vspp·(Csd/Cpix) (7)

Comparing Equations (4) and (7) to each other, it can be seen that by setting the source-drain capacitance Csd of the blue pixel B to be approximately a half of that of the other pixels, the variation in the drain voltage of the blue pixel B can be almost the same as in a situation where a display operation is conducted in a single color by any other pixel.

In the equations described above, the parasitic capacitance Csd(its own) between its own source and the drain and the parasitic capacitance Csd(others) between others' source and the drain are supposed to be the same and are both identified by Csd. Naturally, however, Csd(its own) and Csd(others) may be different from each other. In that case, the sum (or the average) of Csd(its own) of the blue pixel B and Csd(others) just needs to be smaller than the sum (or the average) of Csd(its own) and Csd(others) of any other pixel. Nevertheless, in order to minimize the variation in drain voltage of the pixels that are located between two signal lines 13 that supply voltages of opposite polarities, it is still preferred that Csd(its own) and Csd(others) be substantially equal to each other. In this description, if “the source-drain capacitance Csd of a pixel is smaller than the source-drain capacitance Csd of another pixel”, then it means that the sum (or the average) of Csd(its own) and Csd(others) of one pixel is smaller than the sum (or the average) of Csd(its own) and Csd(others) of another pixel, no matter whether Csd(its own) and Csd(others) are the same or not.

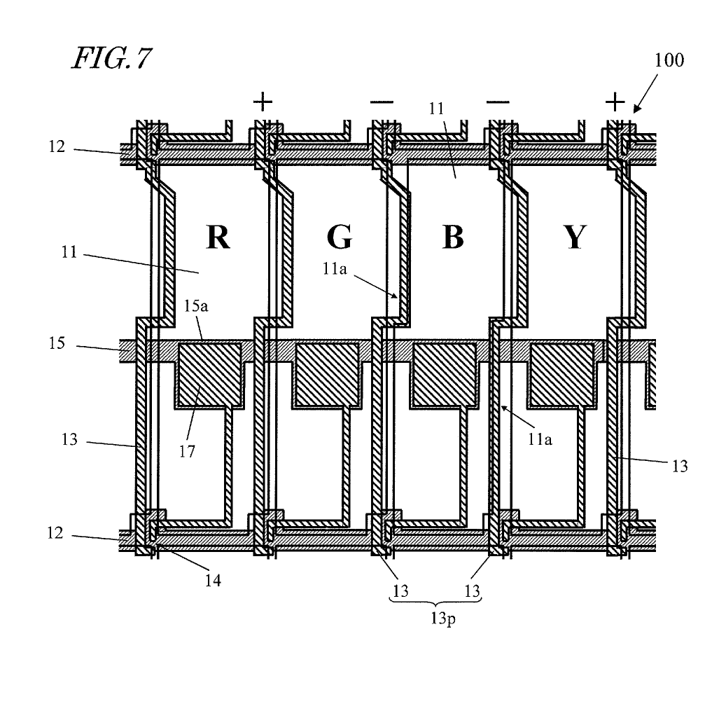

In the arrangements shown in FIGS. 2 and 6, the signal lines 13 are supposed to run straight in the row direction through the display area. However, the signal lines 13 may also be bent as shown in FIG. 7. By arranging zigzag signal lines 13 such as the ones shown in FIG. 7, the variation in source-drain capacitance Csd due to a misalignment that has occurred while the pixel electrodes 11 are formed by photolithographic process can be reduced significantly as disclosed in Japanese Patent Application Laid-Open Publication No. 2001-281696.

Even with such zigzag signal lines 13 adopted, if the pixel electrode 11 of each blue pixel B that is located between two signal lines 13 that supply voltages of the same polarity has notches 11a, the source-drain capacitance Csd of the blue pixel B can still be smaller than that of any other pixel. As a result, the decline in display quality can be minimized.

In the foregoing description, the blue pixels B are supposed to be located between two signal lines 13 that supply voltages of the same polarity (i.e., between the pair of signal lines 13p). However, the present invention is in no way limited to that specific preferred embodiment. Alternatively, the arrangement of the four kinds of pixels in each picture element P may be different from what is illustrated in FIG. 4. And red, green or yellow pixels R, G or Y may be located between the signal lines 13 that supply voltages of the same polarity. Even so, the decline in display quality can also be minimized by setting the source-drain capacitance Csd of the pixels that are located between the signal lines 13 that supply voltages of the same polarity to be smaller than that of the other pixels.

Still, in order to improve the display quality, it is preferred that the blue pixels B be located between the signal lines 13 that supply voltages of the same polarity. The blue pixels B have lower luminosity factor than the other pixels, and therefore, a shift of the display luminance due to a variation in drain potential is less easily recognizable.

### Embodiment 2

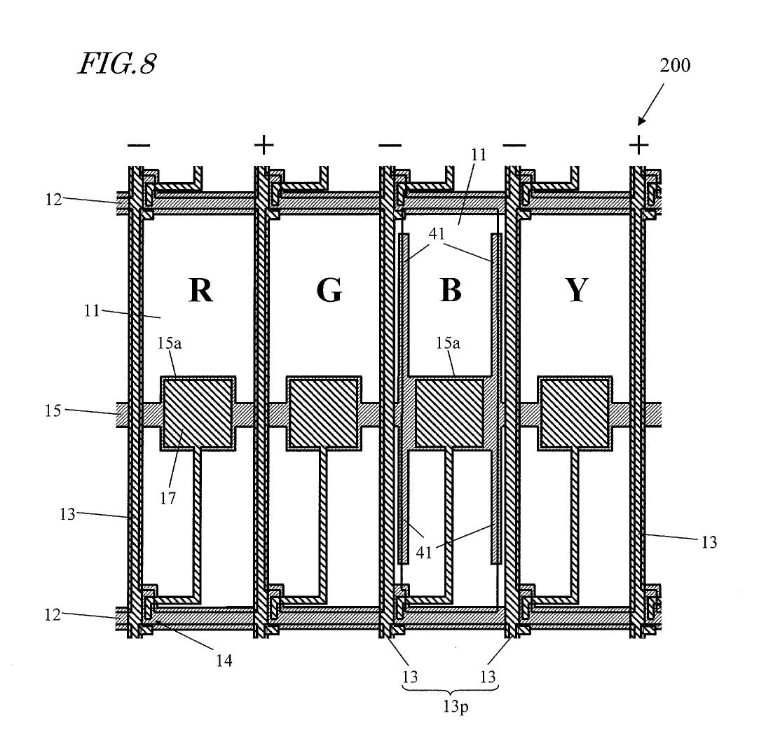

Hereinafter, the structure of a liquid crystal display device 200 as a second specific preferred embodiment of the present invention will be described with reference to FIG. 8, which illustrates four pixels that are arranged consecutively in the row direction just like FIGS. 6 and 7 that illustrate the liquid crystal display device 100 of the first preferred embodiment. The following description will be focused on differences of this liquid crystal display device 200 from the liquid crystal display device 100. In the drawings to be referred to in the following description, any component also included in the liquid crystal display device 100 and having substantially the same function as its counterpart is identified by the same reference numeral and description thereof will be omitted herein.

In this liquid crystal display device 200, the pixel electrode 11 of each blue pixel B that is located between signal lines 13 that supply voltages of the same polarity does not overlap with the signal lines 13 when viewed along a normal to the display screen. Also, shield electrodes 41 are provided for the blue pixel B.

The shield electrodes 41 are arranged near the edges of the pixel electrode 11 and are supplied with a different voltage from the grayscale voltage that is applied to the pixel electrode 11. Also, the shield electrodes 41 are arranged so as to run substantially parallel to the two signal lines 13 that are adjacent to the pixel electrode 11 of the blue pixel B and to overlap with the edges of the pixel electrode 11.

The shield electrodes 41 of this preferred embodiment are made of the same conductor film as the scan lines 12 and the storage capacitor lines 15 and are extended from the storage capacitor counter electrodes 15a, which form part of the storage capacitor lines 15. That is why the shield electrodes 41 are electrically connected to the storage capacitor lines 15 and are supplied with the CS voltage.

In this preferred embodiment, since the pixel electrode 11 of the blue pixel B does not overlap with the signal lines 13, the source-drain capacitance Csd of the blue pixel B is smaller than that of the other pixels. Also, even if the pixel electrode 11 does not overlap with the signal lines 13 when viewed along a normal to the display screen, electrostatic capacitance may still be produced between the signal lines 13 and the pixel electrode 11. However, as the shield electrodes 41 described above are provided according to this preferred embodiment, electric lines of force that are directed from the pixel electrode 11 toward the signal lines 13 can be led to the shield electrodes 41. As a result, it is possible to prevent such a capacitance from being produced between the pixel electrode 11 and the signal lines 13. Consequently, as the shield electrodes 41 are provided, the source-drain capacitance Csd of the blue pixel B further decreases. As a result, the liquid crystal display device 200 of this preferred embodiment can also decrease the shift of the display luminance of the pixels (i.e., the blue pixels B) that are located between the signal lines 13 that supply voltages of the same polarity, and can also minimize the decline in display quality.

In this preferred embodiment, the shield electrodes 41 are supposed to be extended from the storage capacitor counter electrodes 15a and electrically connected to the storage capacitor lines 15. However, the shield electrodes 41 do not have to have such a structure. Rather, the shield electrodes 41 may have any other structure as long as the shield electrodes 41 can be supplied with a different voltage from the grayscale voltage applied to the pixel electrode 11. For example, the shield electrodes 41 may be electrically connected to the scan lines 12.

Furthermore, in order to prevent more securely a capacitance from being produced between the pixel electrode 11 and the signal lines 13, it is preferred that the shield electrodes 41 be arranged so as to overlap with the edges of the pixel electrode 11.

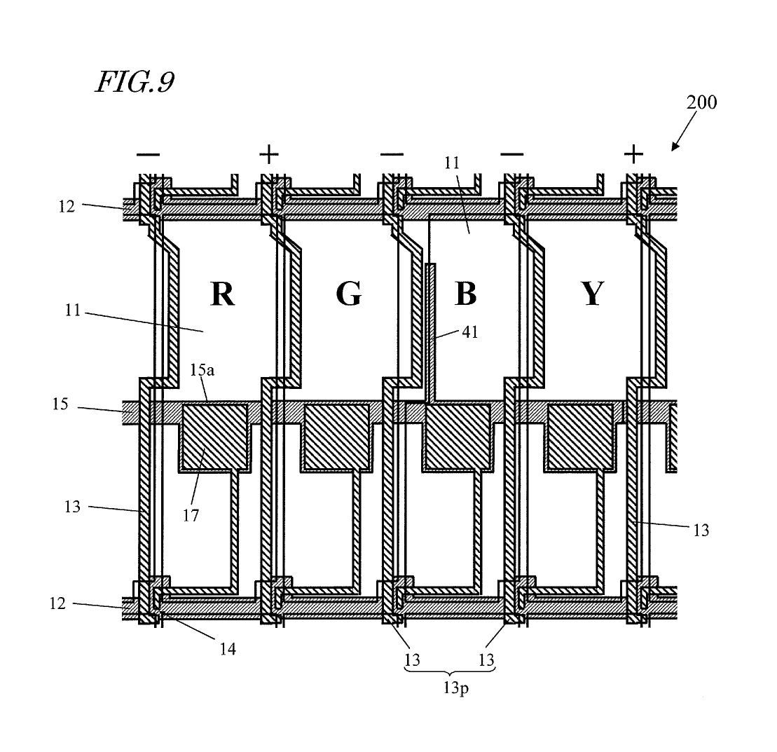

In the arrangement shown in FIG. 8, the signal lines 13 are supposed to run straight in the row direction through the display area. However, the signal lines 13 may also be bent as shown in FIG. 9. By arranging zigzag signal lines 13 such as the ones shown in FIG. 9, the variation in source-drain capacitance Csd due to a misalignment that has occurred while the pixel electrodes 11 are formed by photolithographic process can be reduced significantly as already described with reference to FIG. 7.

Even with such zigzag signal lines 13 adopted, if the pixel electrode 11 of each blue pixel B is arranged so as not to overlap with its own source (i.e., the signal lines 13 that supply the grayscale voltage to the pixel electrode 11 of the blue pixel B) but do overlap with others' source and if the shield electrodes 41 are provided, the source-drain capacitance Csd of the blue pixel B can still be smaller than that of any other pixel. As a result, the decline in display quality can be minimized.

### Embodiment 3

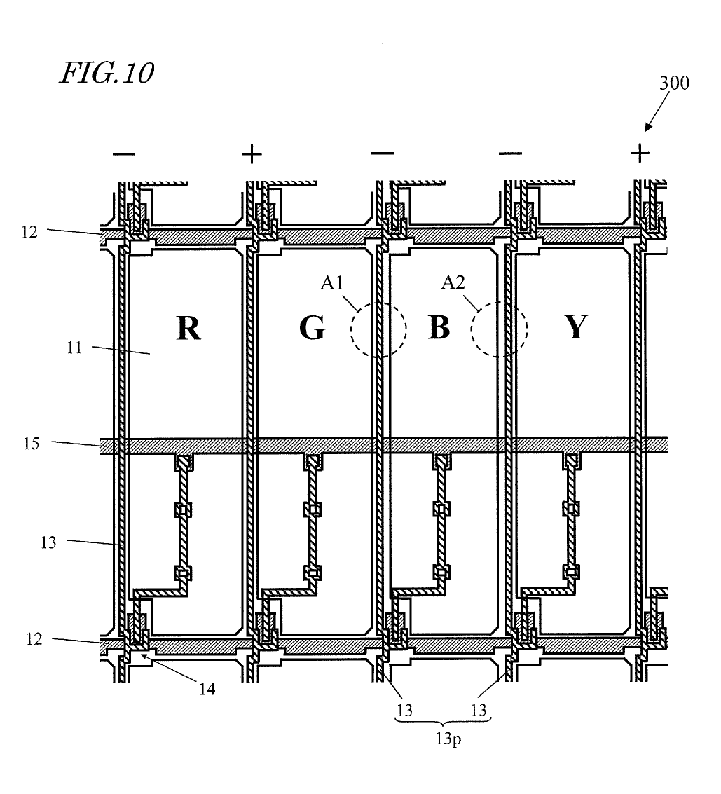

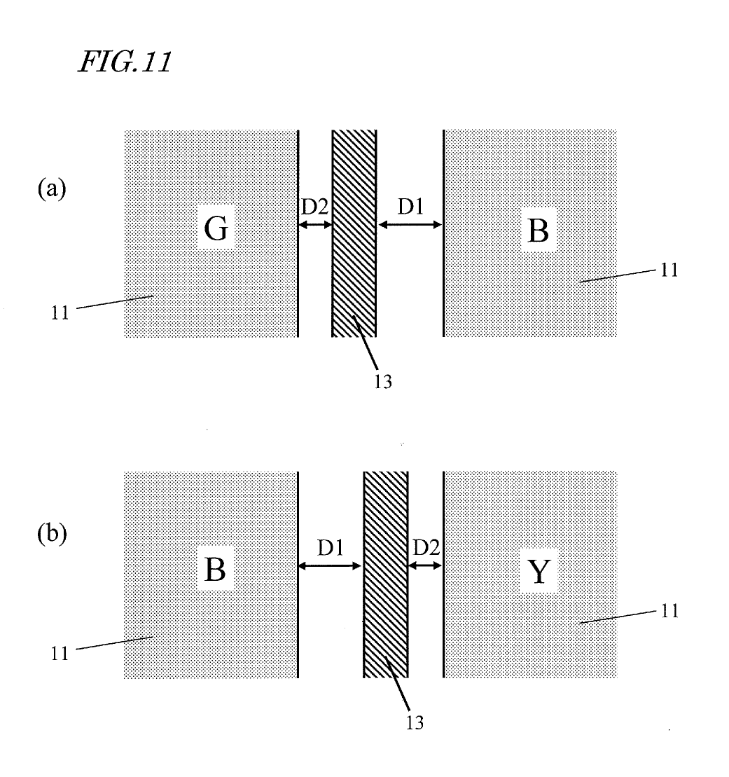

Hereinafter, the structure of a liquid crystal display device 300 as a third specific preferred embodiment of the present invention will be described with reference to FIGS. 10 and 11. FIG. 10 illustrates four pixels that are arranged consecutively in the row direction just like FIGS. 6 and 7 that illustrate the liquid crystal display device 100 of the first preferred embodiment. On the other hand, FIGS. 11(a) and 11(b) respectively illustrate, on a larger scale, the areas A1 and A2 that are indicated by the dashed circles in

FIG. 10. The following description will be focused on differences of this liquid crystal display device 300 from the liquid crystal display device 100.

In this liquid crystal display device 300, when viewed along a normal to the display screen, the pixel electrode 11 does not overlap with any of the two adjacent signal lines 13 in any of red, blue, green and yellow pixels R, B, G and Y. However, the distance D1 from the pixel electrode 11 of each blue pixel B that is located between the signal lines 13 that supply voltages of the same polarity to those two signal lines 13 adjacent to that pixel electrode 11 is longer than the distance D2 from the pixel electrode 11 of any other pixel to the two signal lines 13 that are adjacent to that pixel electrode 11.

That is why the source-drain capacitance Csd of the blue pixel B is smaller than that of any other pixel. Consequently, the liquid crystal display device 300 of this preferred embodiment can also reduce the shift of the display luminance of the pixel (i.e., blue pixel B) that is located between the signal lines 13 that supply voltages of the same polarity and can also minimize the decline in display quality.

In order to make the source-drain capacitance Csd of the blue pixel B much smaller than that of any other pixel, the distance D1 from the pixel electrode 11 of the blue pixel B to the signal lines 13 and the distance D2 from the pixel electrode 11 of the other pixels to the signal lines 13 preferably satisfy the inequality D1≧2·D2. That is to say, it is preferred that the distance D1 be twice or more as long as the distance D2.

It should be noted that in the arrangement shown in FIG. 10, neither the storage capacitor electrodes 17 nor the storage capacitor counter electrodes 15a (i.e., portions of the storage capacitor lines 15 that have an increased width so as to face the storage capacitor electrodes 17) are provided. This is because as the interlayer insulating film 18 is thinner than in the arrangement shown in FIG. 2, a storage capacitor C_{CS} with a sufficiently large capacitance value can be formed by the overlap between the pixel electrode 11 and the storage capacitor line 15. Naturally, depending on the thickness of the interlayer insulating film 18 or the value of the storage capacitance required, the storage capacitor electrodes 17 and the storage capacitor counter electrodes 15a may be provided.

### Embodiment 4

A liquid crystal display device as a fourth specific preferred embodiment of the present invention can carry out a multi-pixel drive (pixel division drive) operation. By adopting the multi-pixel drive, the viewing angle dependence of the γ characteristic, which refers to a phenomenon that the γ characteristic when the screen is viewed straight on is different from the characteristic when it is viewed obliquely, can be reduced significantly. In this case, the “γ characteristic” refers to the grayscale dependence of display luminance. According to the multi-pixel drive, a single pixel is made up of multiple subpixels that can display mutually different luminances, thereby displaying a predetermined luminance associated with a display signal that has been supplied to the pixel. That is to say, the multi-pixel drive is a technique for reducing the viewing angle dependence of the γ characteristic of a pixel by synthesizing together the mutually different γ characteristics of multiple subpixels thereof.

FIGS. 12, 13 and 14 illustrate liquid crystal display devices 400A, 400B and 400C according to this preferred embodiment. In these liquid crystal display devices 400A, 400B and 400C, each pixel includes multiple (specifically, two in this case) subpixels sp1 and sp2 that can exhibit mutually different luminances.

The pixel electrode 11 of each pixel also has two subpixel electrodes 11A and 11B, which are associated with the two subpixels sp1 and sp2, respectively, and which are connected to their associated TFTs 14A and 14B, respectively.

The respective gate electrodes of the two TFTs 14A and 14B are connected in common to the same scan line 12 and have their ON and OFF states controlled with the same gate signal. Also, the respective source electrodes of the two TFTs 14A and 14B are connected in common to the same signal line 13.

A storage capacitor is provided for each of the two subpixels sp1 and sp2. The storage capacitor electrode 17 that forms part of the storage capacitor of one subpixel sp1 is electrically connected to the drain electrode of the TFT 14A. On the other hand, the storage capacitor electrode 17 that forms part of the storage capacitor of the other subpixel sp2 is electrically connected to the drain electrode of the TFT 14B. Also, the storage capacitor counter electrode 15a that forms another part of the storage capacitor of the subpixel sp1 is electrically connected to the storage capacitor line 15A. On the other hand, the storage capacitor counter electrode 15a that forms another part of the storage capacitor of the subpixel sp2 is electrically connected to the storage capacitor line 15B. The respective storage capacitor counter electrodes 15a of the subpixels sp1 and sp2 are independent of each other and are supplied with mutually different voltages (i.e., storage capacitor counter voltages) through the storage capacitor lines 15A and 15B, respectively. By changing the storage capacitor counter voltages applied to the storage capacitor counter electrodes 15A and 15B, mutually different effective voltages can be applied to the respective liquid crystal layers 30 of the subpixels sp1 and sp2 by utilizing the capacitance division technique. As a result, the subpixels sp1 and sp2 can have mutually different display luminances.

In the liquid crystal display devices 400A, 400B and 400C of this preferred embodiment, some pixels (e.g., the blue pixel B in the example illustrated in these drawings) are located between the signal lines 13 that supply voltages of the same polarity. However, by adopting the structure to be described below, the decline in display quality can also be minimized.

Specifically, in the liquid crystal display device 400A shown in FIG. 12, the pixel electrode 11 of the blue pixel B has notches 11a. More specifically, two notches 11a have been cut through each of the two subpixel electrodes 11A and 11B that the pixel electrode 11 of the blue pixel B has.

As the pixel electrode 11 of the blue pixel B has such notches 11a, the combined area where the pixel electrode of the blue pixel B overlaps with two adjacent signal lines 13 is smaller than the combined area where the pixel electrode 11 of any other pixel overlaps with two adjacent signal lines 13. That is why the source-drain capacitance Csd of the blue pixel B is smaller than that of any other pixel. Consequently, the shift of the display luminance of the blue pixel B can be reduced and the decline in display quality can be minimized.

According to this preferred embodiment, since the notches 11a have been cut through each of the two subpixel electrodes 11A and 11B, the effect of reducing the shift of the display luminance can be achieved in each of the multiple subpixels sp1 and sp2 of the blue pixel B.

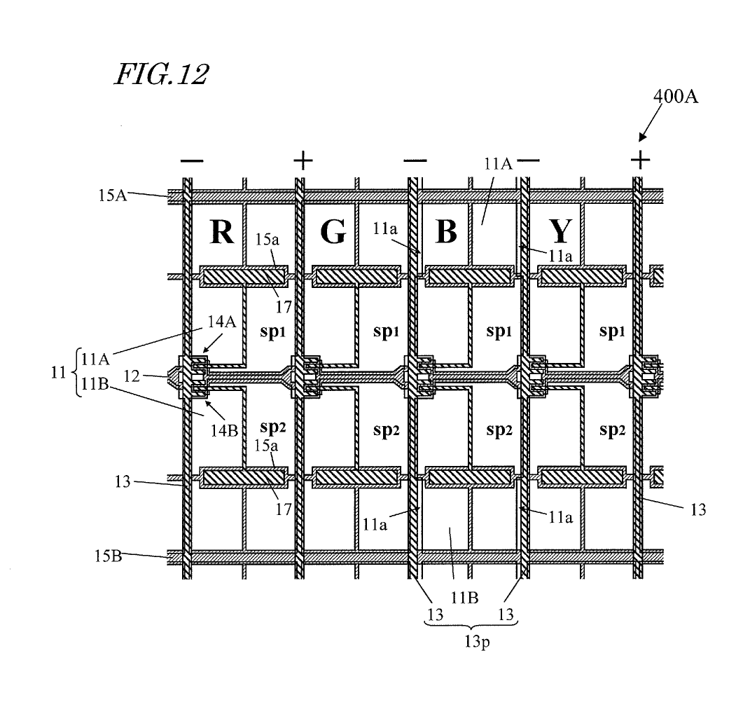

In the liquid crystal display device 400B shown in FIG. 13, on the other hand, the pixel electrode 11 of the blue pixel B does not overlap with the signal lines 13 when viewed along a normal to the display screen. But shield electrodes 41 are provided for the blue pixel B. The shield electrodes 41 are arranged near the edges of the pixel electrode 11, more specifically, in the vicinity of the respective edges of the subpixel electrodes 11A and 11B, and are extended from the storage capacitor lines 15A and 15B.

In this liquid crystal display device 400B, since the pixel electrode 11 of the blue pixel B does not overlap with the signal lines 13, the source-drain capacitance Csd of the blue pixel B is smaller than that of the other pixels.

Also, since the shield electrodes 41 are provided, it is possible to prevent an electrostatic capacitance from being produced between the pixel electrode 11 and the signal lines 13. Consequently, as the shield electrodes 41 are provided, the source-drain capacitance Csd of the blue pixel B further decreases. As a result, the shift of the display luminance of the pixels (i.e., the blue pixels B) that are located between the signal lines 13 that supply voltages of the same polarity can be decreased, and the decline in display quality can be minimized.

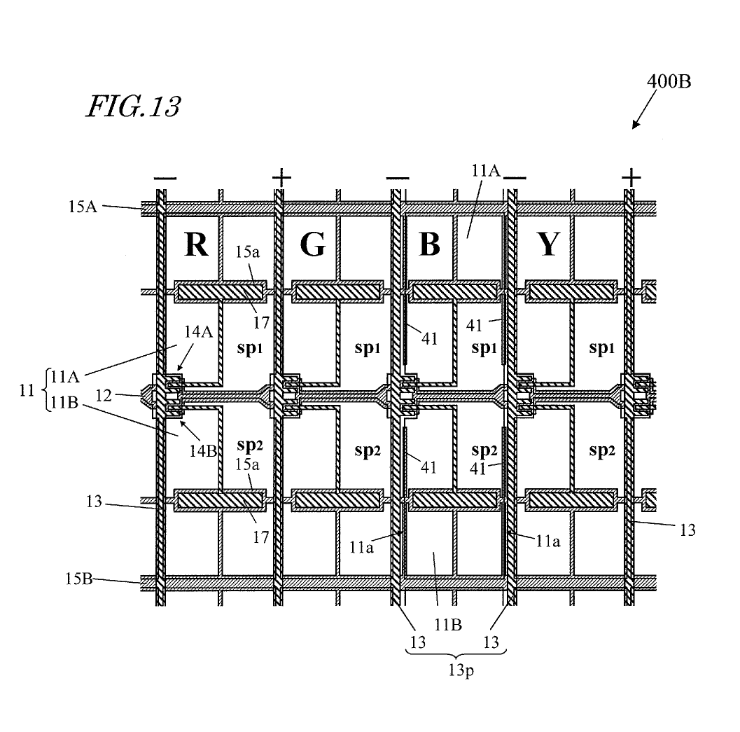

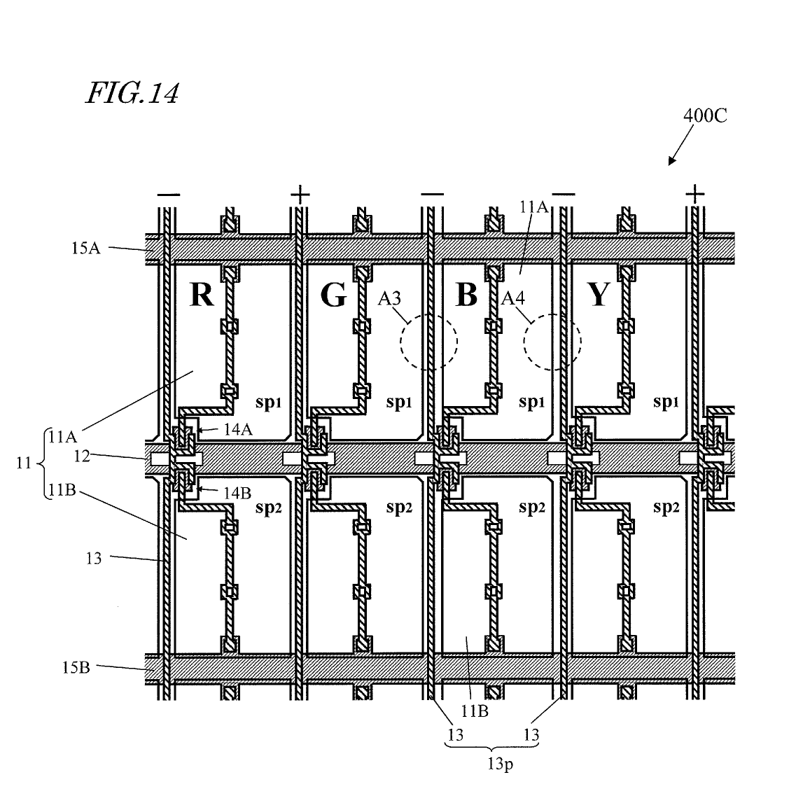

In the liquid crystal display device 400C shown in FIG. 14, when viewed along a normal to the display screen, the pixel electrode 11 does not overlap with the two adjacent signal lines 13 in any of red, blue, green and yellow pixels R, B, G and Y. However, the distance from the pixel electrode 11 of each blue pixel B to the signal lines 13 is different from the distance from the pixel electrode 11 of any other pixel to the two signal lines 13.

FIGS. 15(a) and 15(b) respectively illustrate, on a larger scale, the areas A3 and A4 that are indicated by the dashed circles in FIG. 14. As shown in FIGS. 15(a) and 15(b), the distance D1 from the pixel electrode 11 of each blue pixel B to the two adjacent signal lines 13 is longer than the distance D2 from the pixel electrode 11 of any other pixel to the two adjacent signal lines 13.

That is why the source-drain capacitance Csd of the blue pixel B is smaller than that of any other pixel. Consequently, the liquid crystal display device 400C can also reduce the shift of the display luminance of the pixel (i.e., blue pixel B) that is located between the signal lines 13 that supply voltages of the same polarity and can also minimize the decline in display quality.

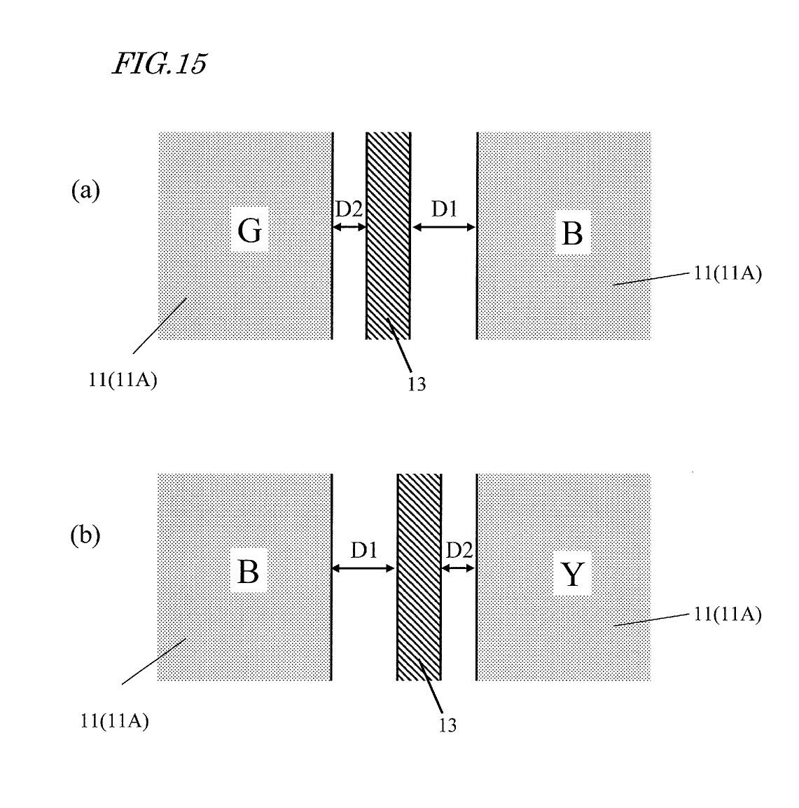

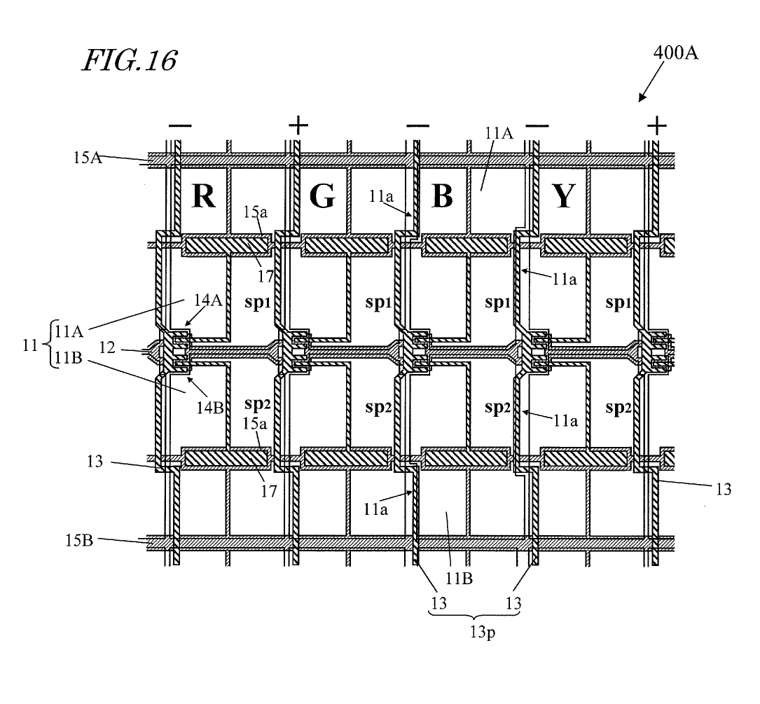

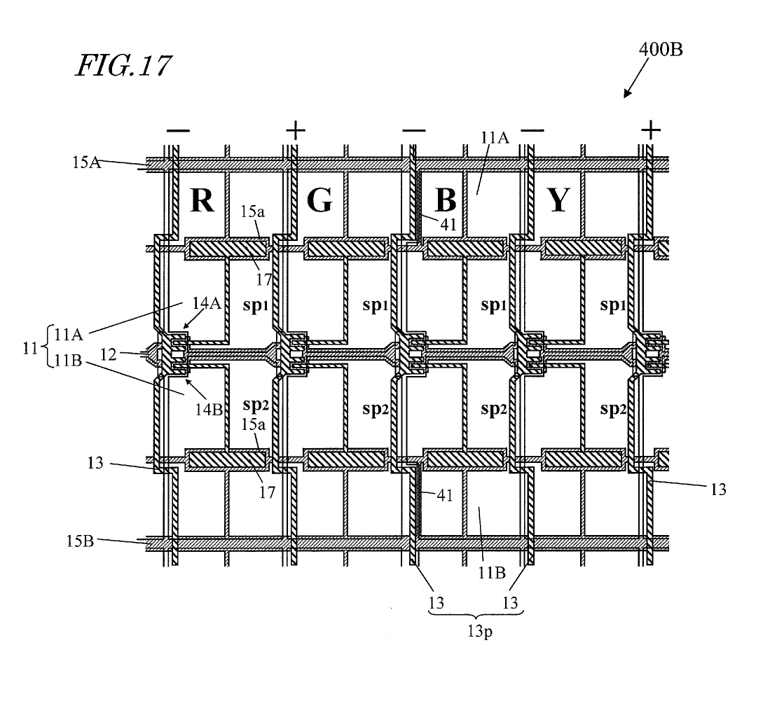

In the arrangements shown in FIGS. 12, 13 and 14, the signal lines 13 are supposed to run straight in the row direction through the display area. However, the signal lines 13 may also be bent as shown in FIGS. 16 and 17. By arranging zigzag signal lines 13 such as the ones shown in FIGS. 16 and 17, the variation in source-drain capacitance Csd due to a misalignment that has occurred while the pixel electrodes 11 are formed by photolithographic process can be reduced significantly as already described with reference to FIG. 7.

Even with such zigzag signal lines 13 adopted, if notches 11a are cut through the pixel electrode 11 of the blue pixel B that is located between the signal lines 13 that supply voltages of the same polarity as shown in FIG. 16, the source-drain capacitance Csd of the blue pixel B can be smaller than that of any other pixel. As a result, the decline in display quality can be minimized. Also, if the pixel electrode 11 of each blue pixel B is arranged so as not to overlap with its own source (i.e., the signal lines 13 that supply the grayscale voltage to the pixel electrode 11 of the blue pixel B) but do overlap with others' source and if the shield electrodes 41 are provided as shown in FIG. 17, the source-drain capacitance Csd of the blue pixel B can still be smaller than that of any other pixel. As a result, the decline in display quality can be minimized, too.

### Other Embodiments

In the first through fourth preferred embodiments of the present invention described above, a single picture element P is supposed to be made up of four kinds of pixels as an example. However, this is just an example of the present invention. Rather, the present invention is broadly applicable for use in a liquid crystal display device in which each picture element P is defined by m different kinds of (where m is an even number that is equal to or greater than four) pixels that display mutually different colors. For example, each picture element P may be defined by six kinds of pixels as shown in FIG. 18. In the arrangement illustrated in FIG. 18, each picture element P includes not only red, green, blue, and yellow pixels R, G, B and Y but also cyan and magenta pixels C and M representing the colors cyan and magenta. Also, in the arrangement illustrated in FIG. 18, the magenta pixels M are located between the signal lines 13 that supply voltages of the same polarity. That is why by cutting notches 11a through the pixel electrode 11 of each magenta pixel M or by providing shield electrodes 41 for the magenta pixel M or by setting the distance from the pixel electrode 11 of the magenta pixel M to the signal lines 13 to be longer than the distance from the pixel electrode 11 of any other pixel to the signal lines 13, the shift of the display luminance of the magenta pixel M from the original level can be reduced significantly and the decline in display quality can be minimized.

As for the respective kinds (i.e., the combination) of pixels that define a single picture element P, the combinations described above are just examples, too. For example, if each picture element P is defined by four kinds of pixels, each picture element P may be defined by either red, green, blue and cyan pixels R, G, B and C or red, green, blue and magenta pixels R, G, B and M. Alternatively, each picture element P may also be defined by red, green, blue and white pixels R, G, B and W as shown in FIG. 19. If the arrangement shown in FIG. 19 is adopted, a colorless and transparent color filter (i.e., a color filter that transmits white light) is arranged in a region of the color filter layer of the counter substrate 20 that is allocated to the white pixel W. With the arrangement shown in FIG. 19 adopted, the color reproduction range cannot be broadened because the primary color added is the color white, but the overall display luminance of a single picture element P can be increased.

Also, in the arrangements shown in FIGS. 4, 18 and 19, m different kinds of pixels are arranged in one row and m columns within each picture element P, and the color filters have a so-called “striped arrangement”. However, this is only an example of the present invention, too. Rather, those pixels may be arranged so that n out of the m kinds of pixels (where n is an even number that is equal to or smaller than m and is a divisor of m) are repeatedly arranged in the same order in the row direction. That is to say, in each picture element P, the m kinds of pixels may be arranged in (m/n) row(s) and n columns. Specifically, m=n may be satisfied as shown in FIGS. 4, 18 and 19, or m≠n. For example, if each picture element P includes eight kinds of pixels, the eight kinds of pixels may be arranged in two rows and four columns in each picture element P.

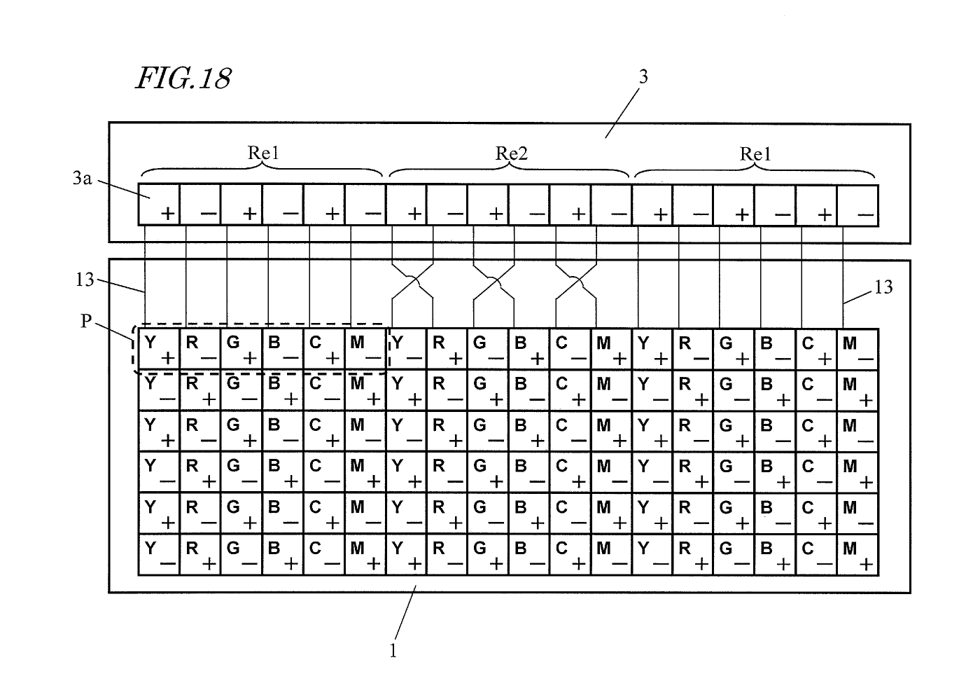

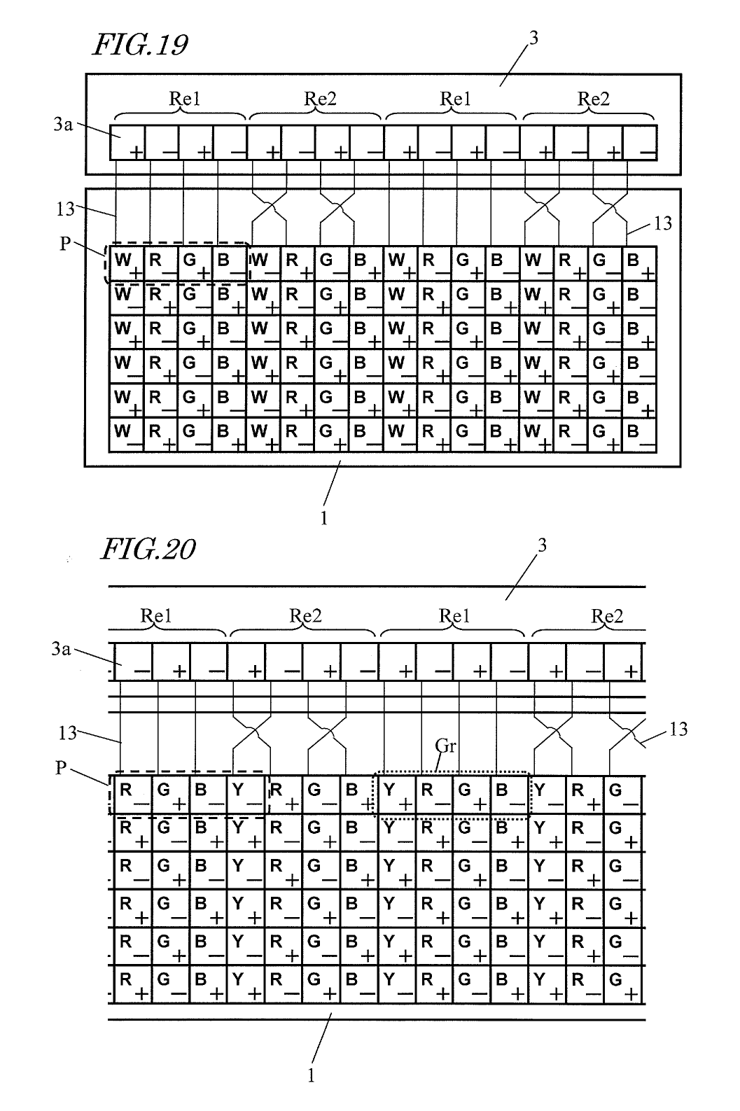

Furthermore, in the preferred embodiments described above, the polarity of the grayscale voltage is supposed to invert every pixel without fail in the row direction within each picture element P. However, the present invention is in no way limited to those specific preferred embodiments. For instance, in the arrangement illustrated in FIG. 20, four kinds of pixels, consisting of red, green, blue, and yellow pixels R, G, B and Y, are arranged in this order from the left to the right within each picture element P, but the grayscale voltage does not invert between the blue and yellow pixels B and Y that are adjacent to each other in the row direction within each picture element P. Nevertheless, even in the arrangement shown in FIG. 20, if attention is paid to a group Gr of pixels in which yellow, red, green and blue pixels Y, R, G and B are arranged in this order from the left to the right on each row of pixels, it can be seen that the polarity of the grayscale voltage never fails to invert every pixel in the row direction within that group Gr of pixels. Consequently, even when the arrangement shown in FIG. 20 is adopted, the effect of the inversion drive (such as the effect of minimizing the generation of flicker) can also be achieved as significantly as when the arrangement shown in FIG. 4 is adopted.

As described above, in the liquid crystal display device of the present invention, the pixels are arranged so that n out of the m kinds of pixels (where m is an even number that is equal to or greater than four and n is an even number that is equal to or smaller than m and is a divisor of m) are repeatedly arranged in the same order in the row direction. That is why each of multiple rows of pixels may include multiple groups of pixels, to each of which n pixels that are arranged consecutively in the row direction belong and in each of which grayscale voltages of opposite polarities are supplied through associated signal lines 13 to two arbitrary adjacent pixels. In this case, each group of pixels may form one picture element P (i.e., one picture element P may agree with one group of pixels) as shown in FIG. 4 or one picture element P and one group Gr of pixels may not agree with each other as shown in FIG. 20.

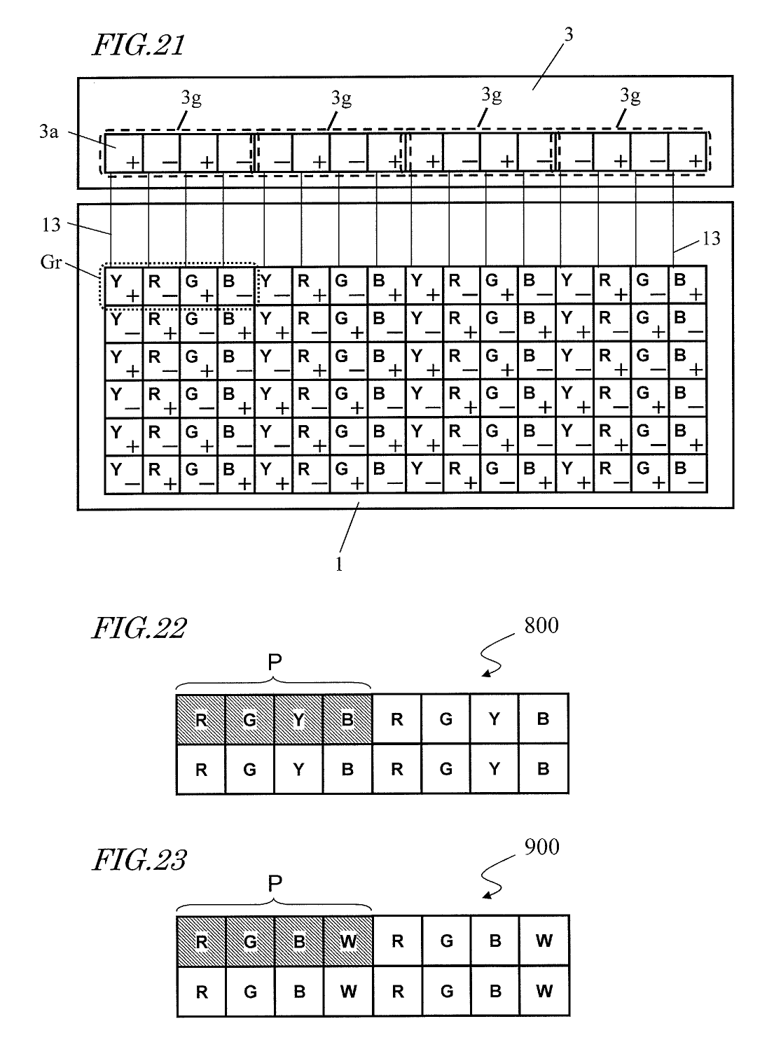

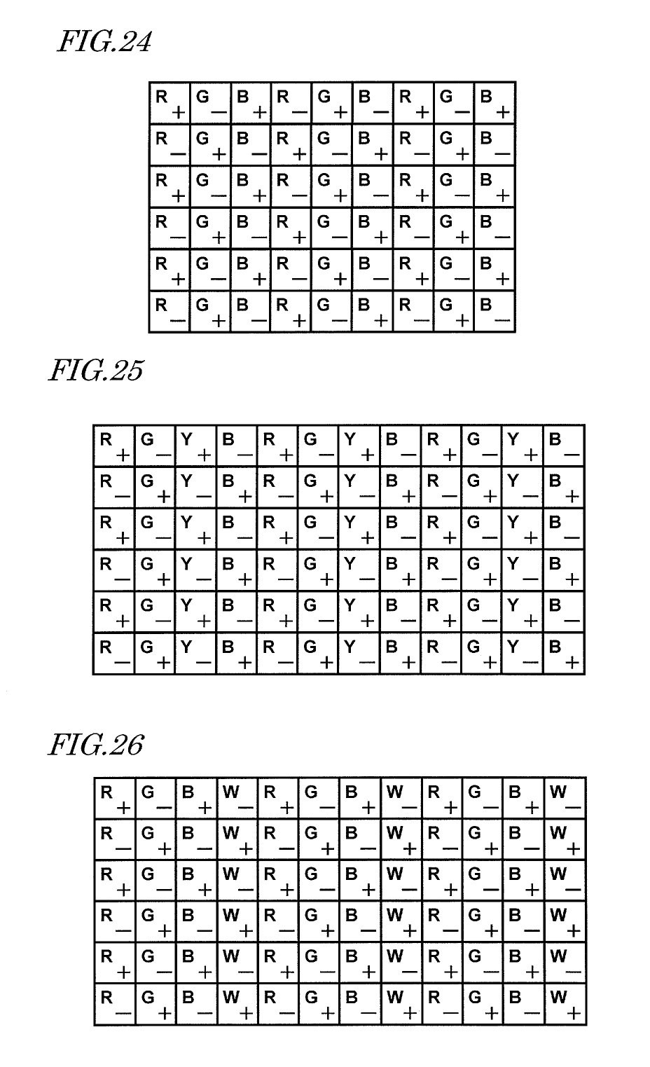

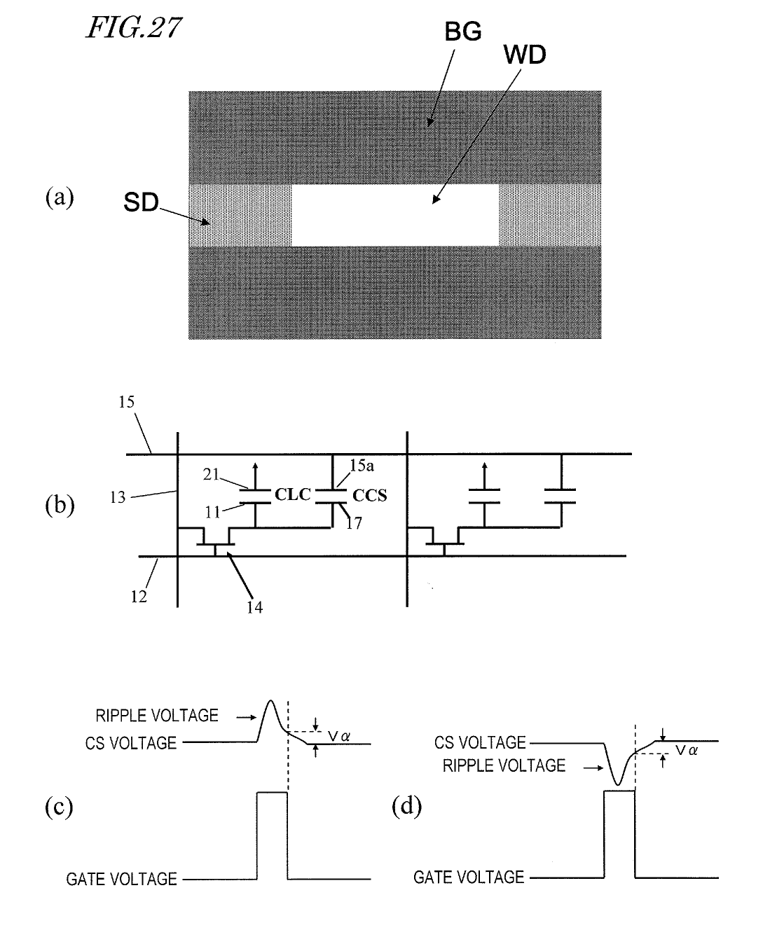

Also, in the arrangement shown in FIG. 4, for example, when the signal lines 13 are connected to the signal line driver 3, the sequential connection regions Re1 and the reverse connection regions Re2 are arranged in the same mixture, thereby carrying out an inversion drive that can avoid casting horizontal shadows. However, the reverse connection regions Re2 do not always have to be provided. For example, the arrangement of multiple output terminals 3a of the signal line driver 3 may be modified as shown in FIG. 21.

In the arrangement shown in FIG. 21, the output terminals 3a include multiple groups 3g of output terminals, to each of which n (e.g., four in this example) output terminals 3a that are arranged consecutively in the row direction belong, just like the group of pixels described above. In each group 3g of output terminals, two arbitrary adjacent output terminals 3a output grayscale voltages of opposite polarities. Also, in two arbitrary ones of the groups 3g of output terminals that are adjacent to each other in the row direction, two output terminals 3a at the same position output grayscale voltages of opposite polarities. Even by adopting such an arrangement, an inversion drive that can avoid casting horizontal shadows can also be carried out as with the arrangement shown in FIG. 4.

### INDUSTRIAL APPLICABILITY

The present invention improves the display quality of a liquid crystal display device, of which each picture element is defined by an even number of pixels, and can be used effectively in a multi-primary-color liquid crystal display device.

### REFERENCE SIGNS LIST

1 LCD panel

2 scan line driver (gate driver)

3 signal line driver (source driver)

3a output terminal

3g group of output terminals

10 active-matrix substrate

10a, 20a transparent substrate

11 pixel electrode

11a notch

11A, 11B subpixel electrode

12 scan line

13 signal line

13p pair of signal lines

14, 14A, 14B thin-film transistor (TFT)

15, 15A, 15B storage capacitor line

15a storage capacitor counter electrode

16 gate insulating film

17 storage capacitor electrode

18 interlayer insulating film

19, 29 alignment film

20 counter substrate

21 counter electrode

29 alignment film

30 liquid crystal layer

40 shield electrode

100, 200, 300 liquid crystal display device

400A, 400B, 400C liquid crystal display device

P picture element

R red pixel

G green pixel

B blue pixel

Y yellow pixel

C cyan pixel

M magenta pixel

W white pixel

sp1, sp2 subpixel

Re1 sequential connection region

Re2 reverse connection region

1. A liquid crystal display device that has a number of pixels, which are arranged in columns and rows to form a matrix pattern, the device comprising:
an active-matrix substrate that includes pixel electrodes, each of which is provided for an associated one of the pixels, a plurality of scan lines that run in a row direction, and a plurality of signal lines that run in a column direction;
a counter substrate that faces the active-matrix substrate;
a liquid crystal layer that is interposed between the active-matrix substrate and the counter substrate; and
a signal line driver that applies a positive or negative grayscale voltage as a display signal to each said signal line,
wherein those pixels include m kinds of (where m is an even number that is equal to or greater than four) pixels that display mutually different colors, and
wherein the pixels are arranged so that n out of the m kinds of pixels (where n is an even number that is equal to or smaller than m and is a divisor of m) are repeatedly arranged in the same order in the row direction, and
wherein each of the rows of pixels that are formed by those pixels includes multiple groups of pixels, to each of which n pixels that are arranged consecutively in the row direction belong, grayscale voltages of mutually opposite polarities being applied through associated signal lines to the pixel electrodes of two arbitrary pixels that are adjacent to each other in each said group of pixels, and
wherein in two arbitrary ones of those groups of pixels that are adjacent to each other in the row direction, grayscale voltages of mutually opposite polarities are applied through their associated signal lines to the pixel electrodes of pixels that display the same color, and
wherein the signal lines include at least one pair of signal lines that are adjacent to each other and that supply grayscale voltages of the same polarity, and
wherein the source-drain capacitance of the pixels that are located between the pair of signal lines is smaller than the source-drain capacitance of the other pixels.

2. The liquid crystal display device of claim 1, wherein when viewed along a normal to a display screen, each said pixel electrode and its associated two adjacent signal lines overlap with each other, and
wherein the area where the pixel electrodes of the pixels that are located between the pair of signal lines and the two signal lines that are adjacent to those pixels overlap with each other is smaller than the area where the pixel electrodes of the other pixels and the two signal lines that are adjacent to those pixels overlap with each other.

3. The liquid crystal display device of claim 2, wherein the pixel electrode of each of the pixels that are located between the pair of signal lines has notches.

4. The liquid crystal display device of claim 1, wherein when viewed along a normal to a display screen, each said pixel electrode and its associated two adjacent signal lines do not overlap with each other, and
wherein the distance from the pixel electrodes of the pixels that are located between the pair of signal lines to the two signal lines that are adjacent to those pixel electrodes is longer than the distance from the pixel electrodes of the other pixels to the two signal lines that are adjacent to those pixel electrodes.

5. The liquid crystal display device of claim 1, wherein the active-matrix substrate further includes shield electrodes, which are arranged in the vicinity of edges of the pixel electrode of each said pixel that is located between the pair of signal lines and which are supplied with a different voltage from the grayscale voltage applied to the pixel electrode.

6. The liquid crystal display device of claim 1, wherein the pixels include red, green and blue pixels representing the colors red, green and blue, respectively.

7. The liquid crystal display device of claim 6, wherein the pixels further include yellow pixels representing the color yellow.

8. The liquid crystal display device of claim 6, wherein the pixels that are located between the pair of signal lines are the blue pixels.

9. The liquid crystal display device of claim 1, wherein m=n, and
wherein the pixels are arranged so that the m kinds of pixels are repeatedly arranged in the same order in the row direction.

10. The liquid crystal display device of claim 9, wherein each said group of pixels forms one picture element.

11. The liquid crystal display device of claim 1, wherein the signal line driver includes a plurality of output terminals that are arranged in the row direction, and
wherein two arbitrary adjacent ones of the output terminals output grayscale voltages of opposite polarities.

12. The liquid crystal display device of claim 11, comprising connection regions where each of the signal lines is connected to an associated one of the output terminals one to one,
wherein the connection regions include a sequential connection region where an i^{th} signal line (where i is a natural number) and an i^{th} output terminal are connected together and reverse connection regions where a j^{th} signal line (where j is a different natural number from i) and a (j+1)^{th} output terminal are connected together and where a (j+1)^{th} signal line and a j^{th} output terminal are connected together.

13. The liquid crystal display device of claim 1, wherein the signal line driver includes a plurality of output terminals that are arranged in the row direction, and
wherein the output terminals include multiple groups of output terminals, each said group including n output terminals that are arranged consecutively in the row direction, and
wherein in each said group of output terminals, two arbitrary adjacent ones of the output terminals output grayscale voltages of opposite polarities, and
wherein in two arbitrary ones of the groups of output terminals that are adjacent to each other in the row direction, two output terminals at the same position output grayscale voltages of opposite polarities.
